(19) United States
(12) Patent Application Publication
(10) Pub. No.: US 2004/0015354 A1
(43) Pub. Date: Jan. 22, 2004

(54) Voice recognition system allowing different number-reading manners

(76) Inventors: Hideo Miyauchi, Kariya-City (JP); Makoto Sakai, Nagoya-City (JP)

Correspondence Address: POSZ & BETHARDS, PLC, 11250 ROGER BACON DRIVE, SUITE 10, RESTON, VA, 20190, US

(21) Appl. No.: 10/434,209

(22) Filed: May 9, 2003

(30) Foreign Application Priority Data
Jul. 16, 2002 (JP) 2002-206553

(51) Int. Cl. G10L 17/00

(52) U.S. Cl. 704/246

(57) ABSTRACT

A recognition dictionary stored in a recognition dictionary storing unit stores a recognition word and a voice content in two manners. In a first manner, the recognition word of a single-digit number and its voice content of reading the single-digit number are correlated with each other. In a second manner, the recognition word of a plural-digit number and its voice content of reading the plural-digit number that includes expression of a figure are correlated with each other. For instance, “12” is thereby recognized, even when a speaker utters to input “12” by reading either “one-two” or “twelve.” As a result, a user selects a reading manner for a phone number so that the user can easily read the phone number.

### CROSS REFERENCE TO RELATED APPLICATIONS

This application is based on and incorporates herein by reference Japanese Patent Application No. 2002-206553 filed on Jul. 16, 2002.

### FIELD OF THE INVENTION

The present invention relates to a voice recognition system recognizing a number uttered in different plural manners. For instance, the numbers such as “12” or “1000” can be read as each single-digit number in serial order such as “one-two” or “one-zero-zero-zero,” or read as a plural-digit number such as “twelve” or “thousand.”

### BACKGROUND OF THE INVENTION

There is a voice recognition system that inputs a phone number by using a voice uttered by a user. In the system, the user is required to read (or utter) the phone number by each digit (numeric character) in serial order (serial single-digit reading). For instance, when a phone number has a long-distance number of “0566,” a local number of “12,” and a subscriber number of “3000”, the phone number is required to be read as “zero,” “five,” “six,” “six,” “one,” “two,” “three,” “zero,” “zero,” and “zero” by serial single-digit reading. The system thereby recognizes the phone number uttered by the user as a number having serial digits of “0566123000.”

A user sometimes reads the phone number in other manners. For instance, the local number of “12” and the subscriber number of “3000” may read as “twelve” and “three thousand,” including figures (figure-included reading or spelled-out reading). However, the voice recognition system does not recognize the figure-included reading.

### SUMMARY OF THE INVENTION

It is an object of the present invention to provide a voice recognition system that allows different number-reading manners so that a user can select a reading manner that enables the user to easily read a number.

To achieve the above object, a voice recognition system is provided with the following. For collating an inputted number uttered by a user, the voice recognition system stores a single-digit number and a first voice content of reading the single-digit number, and a plural-digit number and a second voice content of reading the plural-digit number. Here, the single-digit number and the first voice content are correlated with each other, and the plural-digit number and the second voice content are correlated with each other. When a given number is inputted by the user, the inputted given number is recognized by being collated with the first and second voice contents. This structure enables a user to select a reading manner in which the user can easily read a number.

In another aspect of the present invention, a voice recognition system is provided with the following. For collating an inputted phone number uttered by a user, the voice recognition system instructs the user to input a phone number by dividing into a long-distance number, a local number, and a subscriber number. The system stores recognition dictionaries that include a number and a voice content of reading the number, with respect to each of a long-distance number dictionary, a local number dictionary, and a subscriber number dictionary. The local number dictionary stores a first pair of a single-digit number and a first voice content of reading the single-digit number and a second pair of a plural-digit number and a second voice content of reading the plural-digit number by including a figure. When the long-distance number, the local number, and the subscriber number are inputted by the user according to instructions, the inputted numbers are recognized by collating with the corresponding recognition dictionaries. This structure enables recognition dictionaries to be switched for being collated a voice input according to an input content or input order of a phone number. The collated voice inputs are thereby limited, so that recognition rate of a phone number is prevented from decreasing.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic block diagram showing structure of a car navigation system according to a first and a second embodiments of the present invention;

FIG. 2 is a block diagram showing structure of a voice recognition unit according to the embodiments;

FIG. 3 is a block diagram showing structure of a route assistance unit according to the embodiments;

FIG. 4 is a table showing a recognition dictionary stored in a recognition dictionary storing unit according to the first embodiment;

FIG. 5 is a flowchart diagram explaining overall processing of the car navigation according to the embodiments;

FIG. 6 is a flowchart diagram explaining processing of voice recognition for a phone number according to the first embodiment;

FIG. 7 is a table showing messages stored in a message storing unit according to the first embodiment;

FIG. 8 is a table showing a long-distance number dictionary according to the second embodiment;

FIG. 9 is a table showing a local number dictionary according to the second embodiment;

FIG. 10 is a table showing a subscriber number dictionary according to the second embodiment;

FIG. 11 is a table showing messages stored in a message storing unit according to the second embodiment; and

FIG. 12 is a flowchart diagram explaining processing of voice recognition for a phone number according to the second embodiment

### DETAILED DESCRIPTION OF THE PREFERRED EMBODIMENTS

(First Embodiment)

A car navigation device provided in a vehicle will be explained as an embodiment that a voice recognition system of the present invention is directed to.

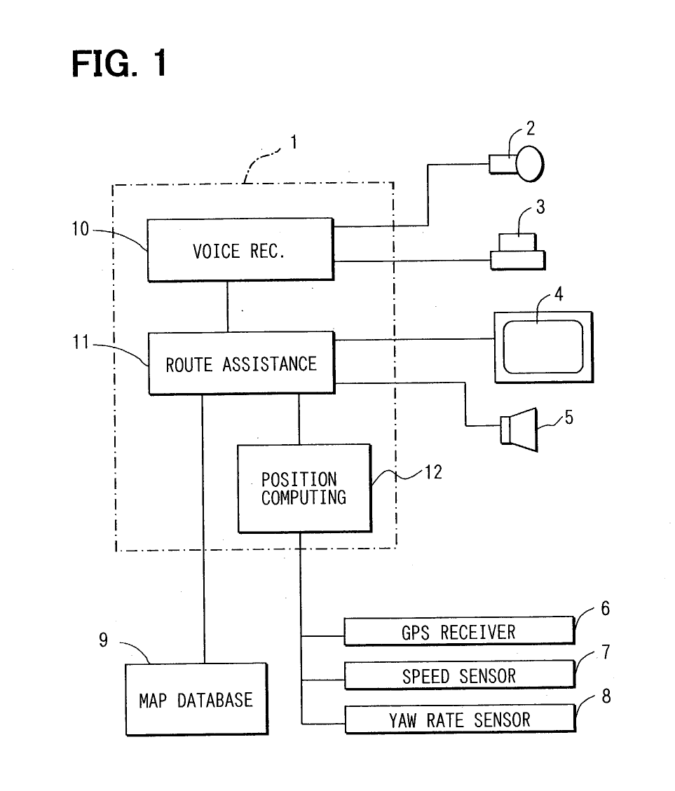

As shown in FIG. 1, the car navigation device 1 includes a voice recognition (REC.) unit 10, a route assistance unit 11, a vehicle position and direction computing unit 12, and a road map drawing unit (not shown). The car navigation device 1 is connected with a microphone 2 for inputting a voice, a talk switch 3, a display unit 4, a speaker 5, a GPS receiver 6, a vehicle speed sensor 7, a yaw rate sensor 8, a map database 9, and the like.

The microphone 2 and the talk switch 3 are used for voice input. As a push button of the talk switch 3 is pushed, an input trigger is sent to the voice recognition unit 10. As the voice recognition unit 10 receives the input trigger, it shifts to a voice input mode of accepting the voice input through the microphone 2.

At the voice input mode, as a user utters a voice, the voice is converted to a voice signal through the microphone 2 to be sent to the voice recognition unit 10. The voice recognition unit 10 recognizes the voice signal to convert into a number or a command corresponding to the voice. For instance, a voice of “one-two” is converted to a number of “12.” The number is sent to the route assistance unit 11. When the route assistance unit 11 receives a phone number having a long-distance number, a local number, and a subscriber number, it then searches for a position corresponding to the phone number to display on the display unit 4.

The display unit 4 is formed of a liquid crystal display showing a road map or the like. A touch panel can be used for the display unit 4.

The speaker 5 is used for outputting voice guidance or various alarms. For instance, it can be a speaker that is previously installed in the vehicle or a speaker that is built in the car navigation device 1.

The GPS receiver 6, the vehicle speed sensor 7, and the yaw rate sensor 8 generate necessary signals (sensor signals) used for computing a current position or a traveling direction of the vehicle. The generated sensor signals are sent to the vehicle position and direction computing unit 12.

The map database 9 is stored in a storage (not shown) and includes map information and road information. Although CD-ROM or DVD-ROM is generally used as the storage depending on a data amount, a memory card or a hard disk drive can be also used. The map information is, for instance, used for drawing a land mark shown in the display unit 4, and formed of data correlated with building names, addresses, phone numbers, coordinates on a map, and the like.

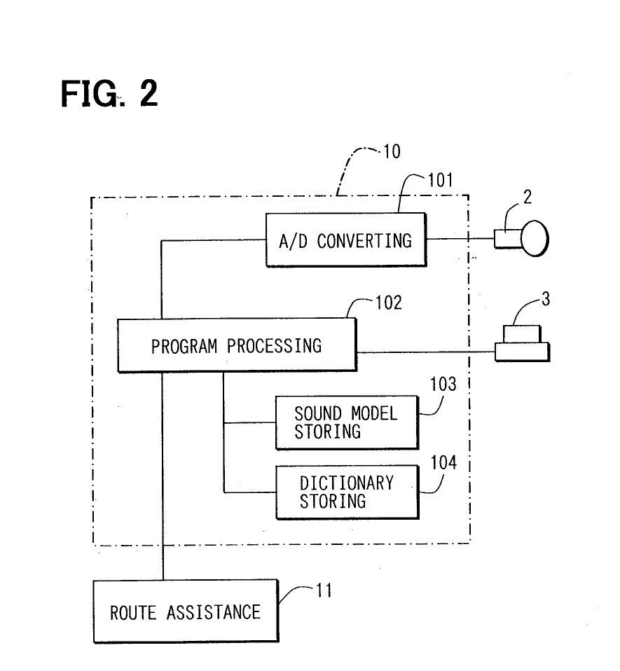

Referring to FIG. 2, the voice recognition unit 10 of the car navigation device 1 will be explained below. The voice recognition unit 10 includes an A/D converting circuit 101, a recognition program processing unit 102, a sound model storing unit 103, a recognition dictionary storing unit 104, and the like.

The A/D converting circuit 101 converts, into a digital signal, an analog voice signal that is received from the microphone 2. The converted digital voice signal is then sent to the recognition program processing unit 102.

The recognition program processing unit 102 converts, utilizing the sound model storing unit 103 and the recognition dictionary storing unit 104, the digital voice signal into a number or a command. The recognition program processing unit 102 analyzes a voice content corresponding to the digital voice signal by using, e.g., known Hidden Markov Model stored in the sound model storing unit 103.

This analyzed voice content is then collated with voice contents stored in the recognition dictionary storing unit 104, so that the most probable recognition word and its corresponding number are extracted.

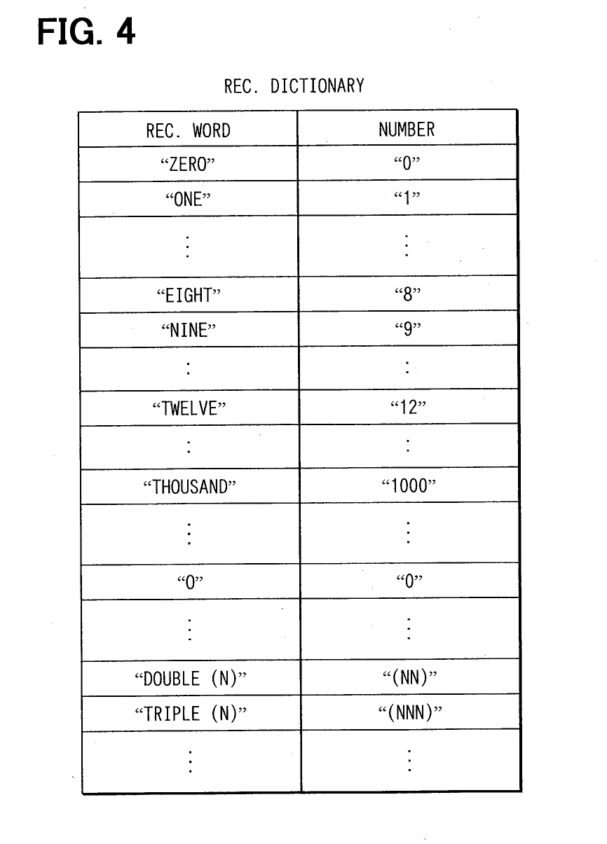

The recognition dictionary storing unit 104 will be explained. The recognition dictionary storing unit 104 includes a recognition dictionary having structure shown in FIG. 4. A recognition word corresponds to a single-digit (numeric character) number such as “1” or a plural-digit number such as “12.” The single-digit number and the plural-digit number are correlated with serial single-digit reading and figure-included reading, respectively. For instance, a single-digit number of “one” is correlated with “1” of the serial single-digit reading, a two-digit number of “12” and a four-digit number of “1000” are correlated with “twelve” and “thousand” of the figure-included reading.

Thus, in the recognition dictionary storing unit 104, the single-digit numbers (0 to 9) are correlated with the serial single-digit reading, while the plural-digit numbers (e.g., “12” or “1000”) are correlated with the figure-included reading. Signals corresponding to the numbers or commands extracted by the recognition program processing unit 102 are then sent to the route assistance unit 11.

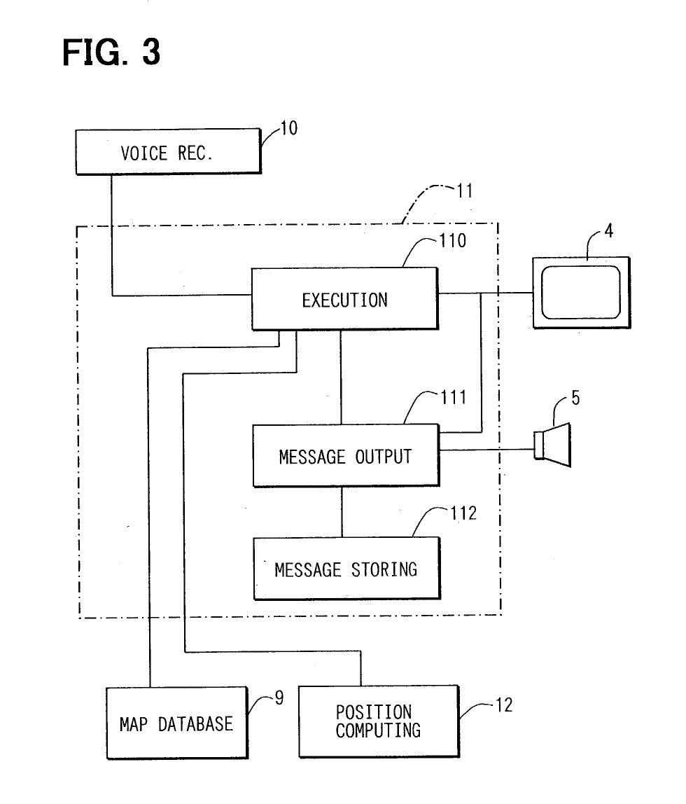

The route assistance unit 11 of the car navigation device 1 will be explained below, referring to FIG. 3. The route assistance unit 11 includes a function execution unit 110, a message outputting unit 111, and a message storing unit 112.

The function execution unit 110 executes a function of displaying a road map surrounding current position of the vehicle, a function of searching for a location through a phone number input, or the like. For instance, in the function of displaying the road map surrounding the current position of the vehicle, as a corresponding command is received, signals relating to the current position and traveling direction of the vehicle are obtained from the vehicle position and direction computing unit 12. Furthermore, map data surrounding the vehicle are read from the map database 9. The signals and the map data are then converted into image signals and displayed on the display unit 4. The function execution unit 110 then sends a command code corresponding to the executed function to the message outputting unit 111.

In the function of searching for the location through the phone number input, a building corresponding to the phone number and their surrounding map are notified as follows: the function execution unit 110 receives a phone number having a long-distance, local, and subscriber numbers from the voice recognition unit 10; it obtains a building name, address, and coordinates corresponding to the inputted phone number from the map database 9; it furthermore obtains map and road information surrounding the obtained coordinates; the obtained information is converted into image signals to be sent to the display unit 4; and the location corresponding to the phone number and its surrounding road map are displayed on the display unit 4.

The message outputting unit 111 receives the command code to extract a corresponding message from the message storing unit 112. The message is displayed on the display unit 4 or outputted to the speaker 5. As shown in FIG. 7, messages stored in the message storing unit 112 are correlated with command codes. For instance, in the function of displaying the road map surrounding the current position of the vehicle, as a command code of “C0001” is received, the message outputting unit 111 notifies “CURRENT POSITION IS TO BE DISPLAYED” corresponding to the command code of “C0001.”

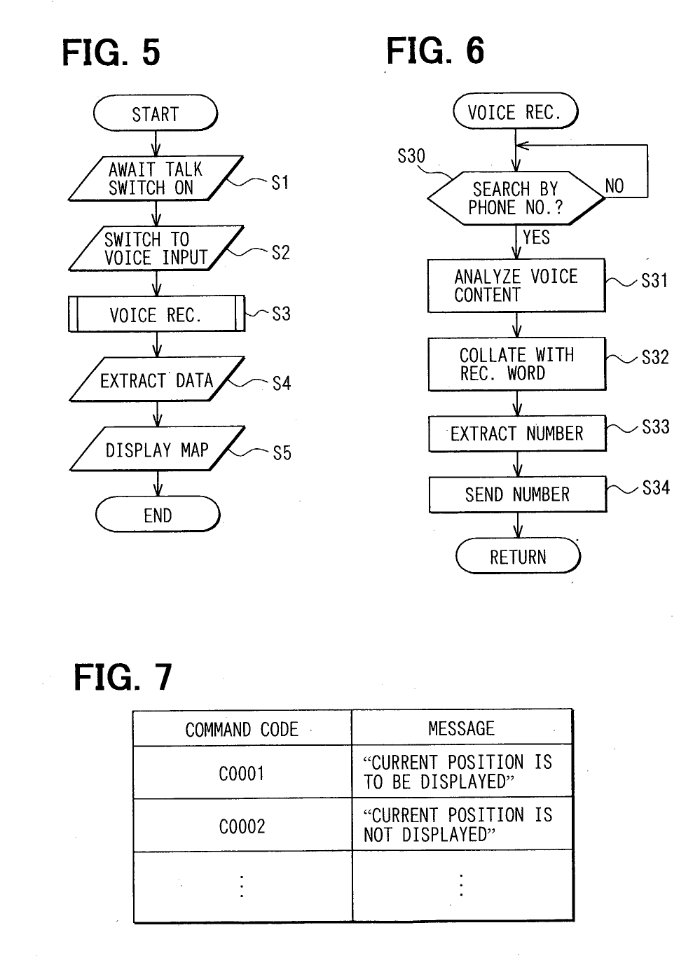

Processing of the car navigation device will be explained regarding the function of searching for the location corresponding to an inputted phone number, referring to FIGS. 5 and 6. As an instance, a case where a phone number of “0220-12-1000” is inputted will be explained below.

At Step 1, as shown in FIG. 5, a waiting state continues till the talk switch 3 is pushed by a user, and the processing proceeds to Step 2 when the talk switch 3 is pushed. At Step 2, the voice recognition unit 10 shifts to an input mode where a voice input can be accepted.

Voice recognition processing at Step 3 will be explained referring to FIG. 6. At Step 30, whether “SEARCH BY PHONE NUMBER” is inputted for searching an objective location is determined. When “SEARCH BY PHONE NUMBER” is determined to be inputted, the processing proceeds to Step 31. Otherwise, the processing remains in the waiting state.

At Step 31, the inputted voice is analyzed for determining the voice content. Here, it is assumed that the uttered voice is analyzed as voice contents of “zero,” “two,” “two,” “zero,” “twelve,” and “thousand.”

At Step 32, the most probable recognition words for the voice contents are extracted through collation in the recognition dictionary of the recognition dictionary storing unit 104.

At Step 33, a number is extracted correspondingly to the extracted recognition words. Here, a plurality of numbers of “0,” “2,” “2,” “0,” “12,” and “1000” are extracted.

At Step 34, signals corresponding to the extracted numbers are sent to the function execution unit 110 of the route assistance unit 11. Here, the extracted numbers are converted into a combined style, i.e., serial ten digits of “0220121000.”

At Step 4 in FIG. 5, data corresponding to a phone number of the ten-digit number sent from the voice recognition unit 10 are extracted from the map database 9. The data include a building name, an address, and coordinates. Information of a map or road surrounding the extracted coordinates is furthermore extracted.

At Step 5, the extracted data and information are converted into image signals to be sent to the display unit 4. The location corresponding to the inputted phone number and its surrounding road map are thereby displayed.

As explained above, in recognizing a phone number, the voice recognition system of the present invention collates an inputted voice content by using the recognition dictionary that includes voice contents corresponding to the serial single-digit reading and also the figure-included reading. Thereby, even when a user selects either the serial single-digit reading of “one-two” or the figure-included reading of “twelve,” a number of “12” is recognized.

Furthermore, the recognition dictionary includes repetition words and substitution words. As shown in FIG. 4, the repetition words are such as “double” or “triple,” while the substitution words are such as “o” indicating “0.” Even when a user reads “1000” as “one-zero-zero-zero,” “one-o-o-o,” “one triple zero,” or “one triple o” that is euphonious, a number of “1000” is properly recognized. Therefore, the user can select a reading manner that enables the user to easily read the phone number.

Furthermore, the present invention can be directed not only to a function of searching a location in a car navigation device but also other instances. The instances are such as a function of inputting a destination by a phone number, or a function of calling to a fixed phone by using voice input of a phone number in a cell phone.

(Second Embodiment)

A second embodiment is similar with the first embodiment in many aspects. Different features are as follows: a recognition dictionary storing unit 104 includes three dictionaries of a long-distance phone number, a local phone number, and a subscriber phone number; messages stored in a message storing unit 112 include messages corresponding to input manners of a phone number; and the input manners are notified to a user for guiding a voice input when the user inputs the long-distance phone number, the local phone number, or the subscriber phone number.

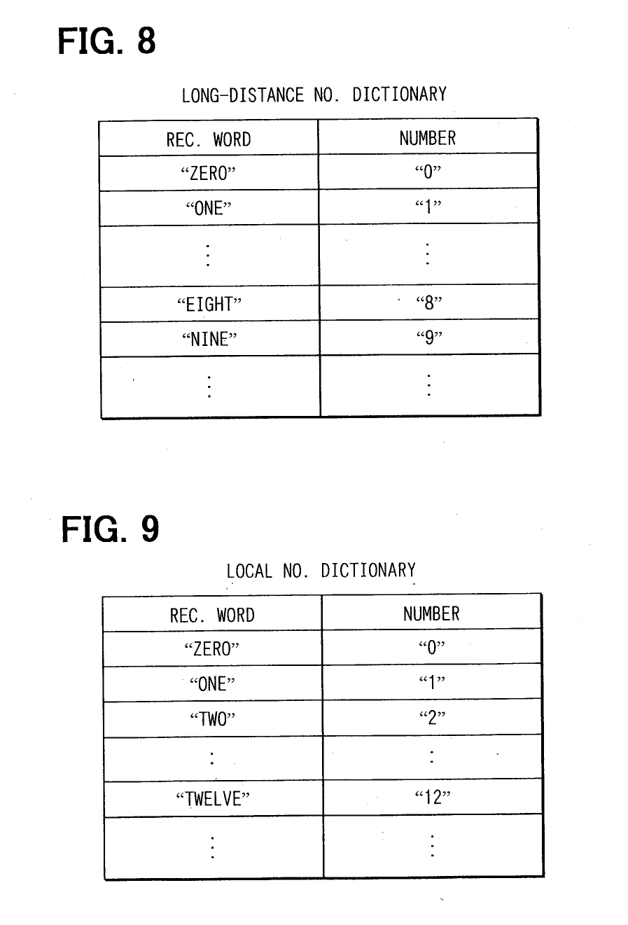

The recognition dictionary storing unit 104 of the second embodiment includes the three recognition dictionaries shown in FIGS. 8 to 10. A long-distance number dictionary shown in FIG. 8 is used for recognizing the long-distance phone number. It stores recognition words and single-digit numbers, both of which are correlated with each other. Namely, the recognition words correspond to the single-digit numbers, so that the recognition words are used for serial single-digit reading.

A local number dictionary shown in FIG. 9 is used for recognizing the local phone number. It stores recognition words and single-digit or plural-digit numbers. The recognition words corresponding to the plural-digit numbers are used for figure-included reading, while the recognition words corresponding to the single-digit numbers are used for the serial single-digit reading. For instance, a two-digit number of “12” is stored with being correlated with a recognition word of “twelve.”

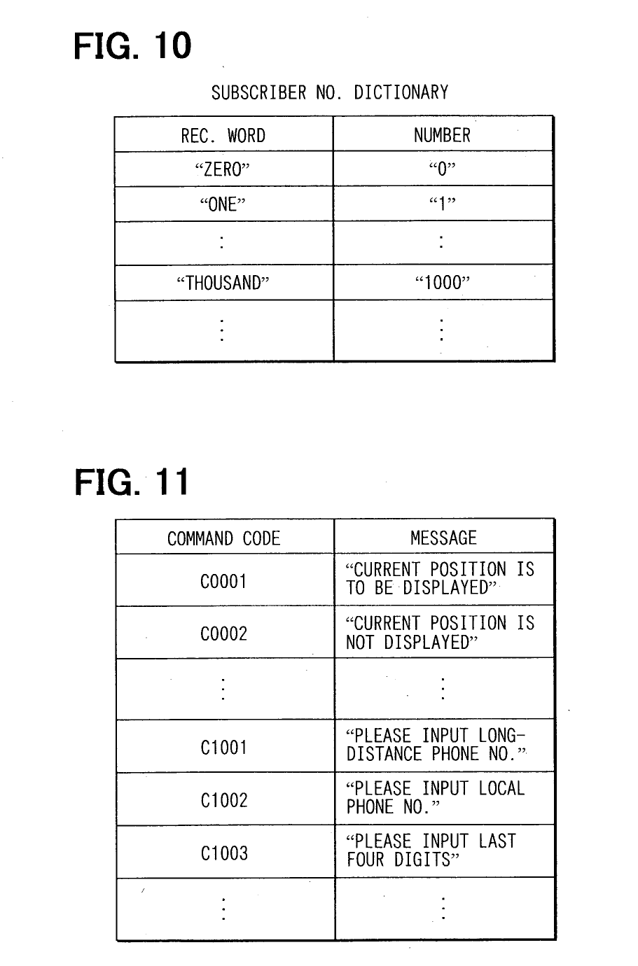

A subscriber number dictionary shown in FIG. 10 is used for recognizing the subscriber phone number. It stores recognition words and single-digit or four-digit numbers. The recognition words corresponding to the four-digit numbers are used for the figure-included reading, while the recognition words corresponding to the single-digit numbers are used for the serial single-digit reading. For instance, a four-digit number of “1000”, is stored with being correlated with a recognition word of “thousand.”

Messages stored in the message storing unit 112 of the second embodiment are shown in FIG. 11. Messages having command codes of “C1001,” “C1002,” and “C1003” correspond to a function of searching a location through a phone number input. The message outputting unit 111 receives a command code correlated with input order of the phone number from the function executing unit 110. It then extracts a message corresponding to the received command code from the message storing unit 112 to output to the display unit 4 or the speaker 5 for guiding a voice input to the user.

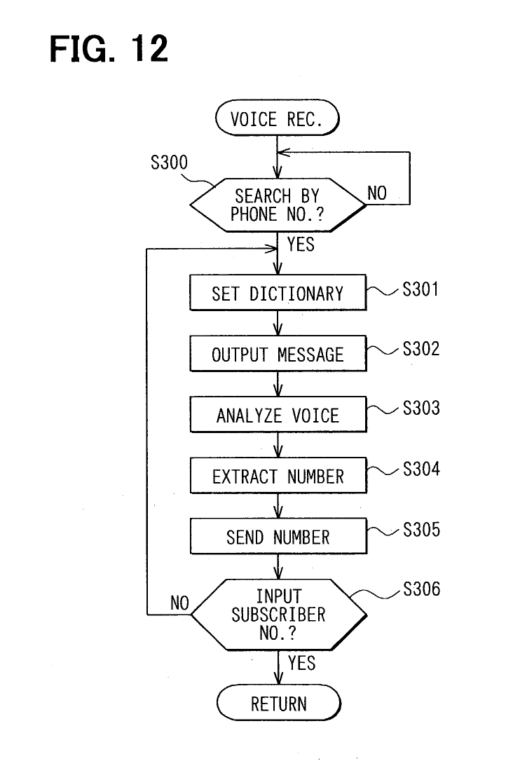

Processing of voice recognition for a phone number of the second embodiment that includes guiding the voice input of the phone number will be explained, referring to FIG. 12. This processing is executed within the processing explained in the first embodiment of FIG. 5. Hereafter, it is assumed that a phone number of “0220-12-1000” is inputted via voice by a user.

At Step 300, whether “SEARCH BY PHONE NUMBER” is inputted for searching an objective location is determined. When “SEARCH BY PHONE NUMBER” is determined to be inputted, processing proceeds to Step 301. Otherwise, the processing remains in a waiting state.

At Step 301, for the subsequent processing at Steps 303 and 304, a long-distance number dictionary is set as a recognition dictionary of the recognition dictionary storing unit 104 to be used for extracting a recognition word. At Steps 303 and 304, a recognition word is extracted through collation, and a number corresponding to the recognition word is extracted from the long-distance number dictionary.

At Step 302, a signal notifying that a long-distance number dictionary is set as the recognition dictionary is sent to the function execution unit 110. The function execution unit 110 then sends a command code of “C1001” corresponding to a long-distance phone number to the massage outputting unit 111. The message outputting unit 111 then extracts a message corresponding to the command code of “C1001” from the message storing unit 112 to output to the display unit 4 or the speaker 5. A message of “please input a long-distance phone number” is thereby notified to the user.

At Step 303, the user utters to input the long-distance phone number according to the message notified at Step 302. Voice contents are then analyzed from the uttered voice. As a result of analyzing, “zero,” “two,” “two,” and “zero” are recognized as the voice contents.

At Step 304, the most probable recognition word for the analyzed voice contents are extracted through the collation in the long-distance phone number dictionary of the recognition dictionary storing unit 104. Numbers corresponding to the extracted recognition words are then extracted. Here, “0,” “2,” “2,” and “0” are extracted for serial numbers of “zero,” “two,” “two,” and “zero.”

At Step 305, signals corresponding to the serial numbers are sent to the route assistance unit 11. Here, the extracted serial numbers are combined to be sent as a form of four-digit number of “0220.” The route assistance unit 11 accordingly displays the received four-digit number on the display unit 4.

At Step 306, whether a subscriber phone number is extracted is determined. When the subscriber phone number is determined to be extracted, the processing of the voice recognition is terminated. Otherwise, the processing returns to Step 301. In the above explanation, only long-distance phone number is extracted, so that the processing returns to Step 301.

Again, at Step 301, based on the order of the phone number input, a local phone number dictionary is set as a next recognition dictionary to be used for extracting a recognition word.

At Step 302, similarly to the above explanation, the function execution unit 110 sends a command code of “C1002” corresponding to a local phone number to the massage outputting unit 111. The message outputting unit 111 then extracts a message corresponding to the command code of “C1002” from the message storing unit 112 to output to the display unit 4 or the speaker 5. A message of “please input a local phone number” is thereby notified to the user.

At Step 303, the user utters to input the local phone number according to the message notified at Step 302. Voice contents are then analyzed from the uttered voice. As a result of analyzing, “twelve” is recognized as the voice contents.

At Step 304, the most probable recognition word for the analyzed voice contents is extracted through the collation in the local phone number dictionary of the recognition dictionary storing unit 104. A number corresponding to the extracted recognition word is then extracted. Here, “12” is extracted for a figure-included number of “twelve.”

At Step 305, signals corresponding to the figure-included number are sent to the route assistance unit 11. The route assistance unit 11 accordingly displays the received two-digit number on the display unit 4.

At Step 306, again, whether the subscriber phone number is extracted is determined. In the above explanation, since the subscriber phone number is not extracted yet, so that the processing returns to Step 301.

Again, at Step 301, based on the order of the phone number input, a subscriber number dictionary is set as a last recognition dictionary to be used for extracting a recognition word.

At Step 302, similarly to the above explanation, the function execution unit 110 sends a command code of “C1003” corresponding to a subscriber phone number to the massage outputting unit 111. The message outputting unit 111 then extracts a message corresponding to the command code of “C1003” from the message storing unit 112 to output to the display unit 4 or the speaker 5. A message of “please input last four digits” is thereby notified to the user.

At Step 303, the user utters to input the subscriber phone number according to the message notified at Step 302. Voice contents are then analyzed from the uttered voice. As a result of analyzing, “thousand” is recognized as the voice contents.

At Step 304, the most probable recognition word for the analyzed voice contents is extracted through the collation in the subscriber number dictionary of the recognition dictionary storing unit 104. A number corresponding to the extracted recognition word is then extracted. Here, “1000” is extracted for a figure-included number of “thousand.”

At Step 305, signals corresponding to the figure-included number are sent to the route assistance unit 11. The route assistance unit 11 accordingly displays the received four-digit number on the display unit 4.

At Step 306, again, whether the subscriber phone number is extracted is determined. Here, the subscriber phone number is determined to be extracted, so that the processing of the voice recognition is terminated thereby to return to the processing shown in FIG. 5.

As explained above, the voice recognition system of this embodiment switches recognition dictionaries for collating a voice input according to an input content or input order of a phone number by a user. The collated voice inputs are thereby limited, so that recognition rate of a phone number is prevented from decreasing.

Furthermore, regarding a local phone number and a subscriber phone number, serial single-digit reading and figure-included reading can be simultaneously accepted, so that a user selects a reading manner in which the user easily reads the phone number.

Since “0” is, in general, a first digit of a long-distance phone number, a user hardly reads the long-distance phone number by the figure-included reading. A long-distance number dictionary can thereby stores only a pair of a single-digit number and a recognition word that is correlated with voice contents by the serial single-digit reading.

Furthermore, messages are notified according to a content of a voice input of a long-distance phone number, a local phone number, or a subscriber phone number, so that an input guidance for the phone numbers are enabled to be easily understood by the user.

In the second embodiment, a recognition dictionary storing unit 104 is formed of three independent dictionaries of a long-distance phone number, a local phone number, and a subscriber phone number. In each dictionary, a recognition word is stored with being correlated with a single-digit number corresponding to the serial single-digit reading or a plural-digit number corresponding to the figure-included reading. Therefore, the recognition dictionary can be differently formed of a dictionary for the serial single-digit reading and a dictionary for the figure-included reading. In this dictionary formation, voice inputs of a long-distance phone number are collated in the dictionary for the serial single-digit reading, while voice inputs of a local and subscriber phone numbers are collated in both dictionaries for the serial single-digit reading and the figure-included reading.

What is claimed is:

1. A voice recognition system comprising:
voice inputting means for inputting a voice uttered by a user;
first storing means for storing a single-digit number and a first voice content of reading the single-digit number, wherein the single-digit number and the first voice content are correlated with each other;
second storing means for storing a plural-digit number and a second voice content of reading, by including a figure, the plural-digit number, wherein the plural-digit number and the second voice content are correlated with each other; and
recognizing means for recognizing, when a phone number is inputted by the user through the voice inputting means, the inputted phone number by collating with the first voice content and the second voice content.

2. A voice recognition system comprising:
voice inputting means for inputting a voice uttered by a user;
instructing means for instructing the user to input a phone number through the voice inputting means by dividing into a long-distance number, a local number, and a subscriber number;
storing means for storing recognition dictionaries that include a number and a voice content of reading the number, with respect to each of a long-distance number dictionary, a local number dictionary, and a subscriber number dictionary, wherein the number and the voice content are correlated with each other; and
recognizing means for recognizing, when the long-distance number, the local number, and the subscriber number are inputted by the user according to instructions by the instructing means, the inputted numbers by collating with the corresponding recognition dictionaries,
wherein the local number dictionary stores a first pair of a single-digit number and a first voice content of reading the single-digit number, and a second pair of a plural-digit number and a second voice content of reading, by including a figure, the plural-digit number, and
wherein the single-digit number and the first voice content are correlated with each other, and the plural-digit number and the second voice content are correlated with each other.

3. A voice recognition system according to claim 2,
wherein the subscriber number dictionary stores a certain pair of a single-digit number and a certain voice content of reading the single-digit number, and a given pair of a plural-digit number and a given voice content of reading, by including a figure, the plural-digit number, and
wherein the single-digit number and the certain voice content are correlated with each other, and the plural-digit number and the given voice content are correlated with each other.

4. A voice recognition system according to claim 2,
wherein the long-distance number dictionary stores a predetermined pair of a single-digit number and a predetermined voice content of reading the single-digit number, wherein the single-digit number and the predetermined voice content are correlated with each other.

5. A voice recognition system according to claim 2,
wherein the instructing means includes:
message storing means for storing messages corresponding to inputs of the long-distance number, the local number, and the subscriber number;
message extracting means for extracting the stored messages based on the inputs of the long-distance number, the local number, and the subscriber number; and
message notifying means for notifying the extracted message.

6. A voice recognition system comprising:
voice inputting means for inputting a voice uttered by a user;
storing means for storing a plurality of first pairs of a single-digit number and a first voice content of reading the single-digit number, and a plurality of second pairs of a plural-digit number and a second voice content of reading the plural-digit number, wherein the single-digit number and the first voice content are correlated with each other, and wherein the plural-digit number and the second voice content are correlated with each other; and
recognizing means for recognizing, when a given number is inputted by the user through the voice inputting means, the inputted given number by collating with the first and second voice contents in the storing means.

7. A voice recognition system according to claim 6,
wherein the given number includes a phone number.

8. A voice recognition system according to claim 6,
wherein the second voice content includes a voice content of reading, by including a figure, the plural-digit number.

9. A voice recognition system according to claim 6,
wherein the second voice content includes a voice content of reading, by including a repetition word that makes single-digit number repeat, the plural-digit number.

10. A voice recognition method comprising steps of:
storing a plurality of first pairs of a single-digit number and a first voice content of reading the single-digit number, and a plurality of second pairs of a plural-digit number and a second voice content of reading the plural-digit number, wherein the single-digit number and the first voice content are correlated with each other, and wherein the plural-digit number and the second voice content are correlated with each other;
inputting a voice uttered by a user; and
recognizing, when a given number is inputted by the user, the inputted given number by collating with the stored first voice content and the stored second voice content.

11. A voice recognition method comprising steps of:
storing recognition dictionaries that include a number and a voice content of reading the number, with respect to each of a long-distance number dictionary, a local number dictionary, and a subscriber number dictionary, wherein the number and the voice content are correlated with each other, wherein the local number dictionary stores a first pair of a single-digit number and a first voice content of reading the single-digit number, and a second pair of a plural-digit number and a second voice content of reading, by including a figure, the plural-digit number, wherein the single-digit number and the first voice content are correlated with each other, and the plural-digit number and the second voice content are correlated with each other;
instructing a user to input a phone number by dividing into a long-distance number, a local number, and a subscriber number;
inputting a voice uttered by the user; and
recognizing, when the long-distance number, the local number, and the subscriber number are inputted by the user according to instructions, the inputted numbers by collating with the corresponding recognition dictionaries.

12. A voice recognition system comprising:
a control unit;
a voice inputting unit that is connected with the control unit and inputs, to the control unit, a voice uttered by a user;
a first memory that is connected with the control unit and stores a single-digit number and a first voice content of reading the single-digit number, wherein the single-digit number and the first voice content are correlated with each other; and
a second memory that is connected with the control unit and stores a plural-digit number and a second voice content of reading, by including a figure, the plural-digit number, wherein the plural-digit number and the second voice content are correlated with each other,
wherein the control unit recognizes, when a phone number is inputted by the user through the voice inputting unit, the inputted phone number by collating with the first voice content stored in the first memory and the second voice content stored in the second memory.

13. A voice recognition system comprising:
a control unit;
a voice inputting unit that is connected with the control unit and inputs, to the control unit, a voice uttered by a user;
an instructing unit that is connected with the control unit and instructs the user to input a phone number through the voice inputting unit by dividing into a long-distance number, a local number, and a subscriber number; and
a memory that is connected with the control unit and stores recognition dictionaries that include a number and a voice content of reading the number, with respect to each of a long-distance number dictionary, a local number dictionary, and a subscriber number dictionary, wherein the number and the voice content are correlated with each other,
wherein the control unit recognizes, when the long-distance number, the local number, and the subscriber number are inputted by the user according to instructions by the instructing unit, the inputted numbers by collating with the corresponding recognition dictionaries stored in the memory,
wherein the local number dictionary stores a first pair of a single-digit number and a first voice content of reading the single-digit number, and a second pair of a plural-digit number and a second voice content of reading, by including a figure, the plural-digit number, and
wherein the single-digit number and the first voice content are correlated with each other, and the plural-digit number and the second voice content are correlated with each other.

14. A voice recognition system according to claim 13,
wherein the subscriber number dictionary stores a certain pair of a single-digit number and a certain voice content of reading the single-digit number, and. a given pair of a plural-digit number and a given voice content of reading, by including a figure, the plural-digit number, and
wherein the single-digit number and the certain voice content are correlated with each other, and the plural-digit number and the given voice content are correlated with each other.

15. A voice recognition system according to claim 13,
wherein the long-distance number dictionary stores a predetermined pair of a single-digit number and a predetermined voice content of reading the single-digit number, wherein the single-digit number and the predetermined voice content are correlated with each other.

16. A voice recognition system according to claim 13,
wherein the instructing unit includes:
a given control unit;
a given memory that is connected with the given memory and stores messages corresponding to inputs of the long-distance number, the local number, and the subscriber number; and
a notifying unit that is connected with the given control unit and notifies information sent by the given control unit, and
wherein the given control unit extracts the messages stored in the given memory, based on the inputs of the long-distance number, the local number, and the subscriber number to sent as the information to the notifying unit.

17. A voice recognition system comprising:
a control unit:
a voice inputting unit that is connected with the control unit and inputs, to the control unit, a voice uttered by a user; and
a memory that is connected with the control unit and stores a plurality of first pairs of a single-digit number and a first voice content of reading the single-digit number, and a plurality of second pairs of a plural-digit number and a second voice content of reading the plural-digit number, wherein the single-digit number and the first voice content are correlated with each other, and wherein the plural-digit number and the second voice content are correlated with each other,
wherein the control unit recognizes, when a given number is inputted by the user through the voice inputting unit, the inputted given number by collating with the first and second voice contents stored in the memory.

18. A voice recognition system according to claim 17,
wherein the given number includes a phone number.

19. A voice recognition system according to claim 17,
wherein the second voice content includes a voice content of reading, by including a figure, the plural-digit number.

20. A voice recognition system according to claim 17,
wherein the second voice content includes a voice content of reading, by including a repetition word that makes single-digit number repeat, the plural-digit number.
